(19) United States
(12) Patent Application Publication
(10) Pub. No.: US 2025/0125556 A1
(43) Pub. Date: Apr. 17, 2025

(54) FIRE ENCLOSURE

(71) Applicant: Viridian Solar Limited, Cambridge, Cambridgeshire (GB)

(72) Inventors: Stuart Elmes, Cambridge, Cambridgeshire (GB); Kok Thong Tan, Cambridgeshire (GB); Thomas Adams, Cambridgeshire (GB)

(21) Appl. No.: 18/576,988

(22) PCT Filed: Jul. 8, 2022
(86) PCT No.: PCT/EP2022/069095

§ 371 Date: Jan. 5, 2024

(30) Foreign Application Priority Data
Jul. 8, 2021 (GB) 2109882.7

(51) Int. Cl. H01R 13/527; H01R 13/52; H02S 40/30

(52) U.S. Cl. CPC H01R 13/527; H01R 13/5227; H02S 40/30

(57) ABSTRACT

There is provided an apparatus for an enclosure of a direct current connection of a photovoltaic solar panel, the apparatus comprising: a housing comprising at least two parts that, when joined together, form a chamber for surrounding mating direct current connectors with an air gap, the housing comprising at least one support structure for positioning the direct current connectors in a central part of the chamber.

### FIELD

The following relates to a method, apparatus and system related to Direct Current (DC) connectors.

### BACKGROUND

The deployment of solar photovoltaic (PV) power generation systems has achieved exponential growth in recent years due to the high demand of renewable energy and the rapid cost reduction in this technology.

Solar PV modules convert solar energy into DC electricity, which may then be harnessed directly or converted into AC for downstream consumption. PV modules are often electrically connected via DC connectors, either in series or parallel. For example, MC4 connectors are single-contact electrical connectors commonly used for connecting solar panels.

Arcing is a problem that may occur at DC connectors. The term “arcing” refers to a flow of current through a high temperature plasma resulting from a potential difference across an air gap. A number of research projects have concluded that the risk of PV fires comes from either incorrectly made or poorly jointed connectors, such as from different manufacturers and/or poor installation practices. The risk of arcing will increase over time as the joints degrade. The high temperatures caused by arcing can lead to a fire starting around the DC connector.

Consequently, DC connectors used in solar PV systems are designed to minimise the risk of arcing. This is done through a rigorous conductor design and a relevant Ingress Protection (IP) against dust and water ingress, typically up to an IP68 classification.

Several mechanisms have been developed for minimising the risk of fires from arcing.

As a first example, several industry regulatory provisions have been brought in in different jurisdictions to minimise the risk of fires. A common practice in the industry is to instigate robust installation training programmes and to ban the usage of mis-matched connectors from different manufacturers. Both approaches failed to eradicate the problem as evidence of PV fires resulting from DC arc continue to occur. As a result, certain territories have imposed mandatory arc fault detection in PV solar systems, whereby any PV system with a maximum voltage greater than 80 volts is protected by a DC arc-fault circuit interrupter. This measure brought about some false nuisance shutdowns, and may not necessarily detect all faults, e.g. slow developing arc.

An alternative approach is to enclose the DC connector in a protective enclosure that in the event of a failure resulting in a DC arc would limit the spread of fire to the connector itself and prevent further damage to surrounding elements.

For example, Liu and Wang put forward a solution in CN201699384U that involves creating a shell in which the DC connectors are located, the shell is then filled with fine sand to prevent the spread of fire.

Similarly, Cai et al. proposed putting the DC connectors in an accommodating cavity and sealing them with fireproof filler in CN105811163A.

However, these solutions that encapsulate the DC connectors can result in adverse consequences when material incompatibility and/or elevated operating temperature compromises the integrity of the connectors and cause thermal events. As a particular example, some fillers may negatively affect the material of the DC connector, leading to faster degradation. The tedious process of encapsulation is also impractical in real-life installations.

Other approaches have examined providing a special cavity shape for minimising arcing. For example, Jiang et al. located DC connectors in an open-ended ceramic protection tube, securing the cables with metal fasteners/pins extending through the tube at each end in CN208738495U. Although the tube may be able to withstand the arcing temperature, it is questionable how the fire can be contained inside the open-ended tube. In addition, the open-ended tube may introduce water passage into the connectors, which may increase the risk of arcing.

As another example approach, new cable connection mechanisms have been developed. For example, Liu and Wen came up with a new cable connection method which utilises fireproof heat shrinkable sleeve to protect the cables, then the two cables are crimped together and secured with a pin in CN209747847U. Shinsuke et al. suggested a similar design concept in JP2020137367A, which makes use of heat resistance tapes to prevent the spread of fire. Both solutions deviate from commonly used standard DC connectors with which solar PV panels are currently fitted, a feature that contributed to the growing acceptance of PV installations.

Although all the above tried to resolve the same problem by containing the spread of fire, these inventions increase the risk of arcing in the first place by providing insufficient ventilation to the connector and/or supporting the accumulation of water around the connector. The elevated operating temperature and the risk of water ingress exacerbate the problem and increase the likelihood of a failure leading to arcing.

### SUMMARY

The present invention is defined by the appended independent claims. Certain more specific aspects are defined by the dependent claims.

According to a first aspect, there is provided an apparatus for an enclosure of a direct current connection of a photovoltaic solar panel, the apparatus comprising: a housing comprising at least two parts that, when joined together, form a chamber for surrounding mating direct current connectors with an air gap, the housing comprising at least one support structure for positioning the direct current connectors in a central part of the chamber.

The at least one support structure may be configured to contact at least one cable connected to one of the mating direct current connectors for causing the direct current connectors to be suspended in air in a central region of the chamber.

The at least one support structure may be configured to inhibit lateral movement of the mating direct current connectors in at least one direction.

The housing may comprise an inner surface facing the chamber that may be at least partially coated in an intumescent material.

The apparatus may comprise at least one first port for providing water egress from the housing.

The apparatus may comprise at least one second port for air flow into and/or out of the chamber.

The at least one first and/or second port may provide an entrance or exit point to a labyrinthine path for exit of water and/or entry of air and/or exit of air.

The at least one first and/or second port may be located at a distal end of at least one part of the housing.

The at least one first port and/or second port may comprise a respective inner surface that may be at least partially coated in an intumescent material.

The housing may comprise an upper part and a lower part that mate together to surround the mating direct current connectors.

The housing may comprise a tubular section having two open ends, and two end caps configured to cover the open ends of the tubular section.

The housing may comprise a dielectric material.

The housing may have at least one outer surface configured to direct water towards an edge of the housing.

According to a second aspect, there is provided an assembly comprising the apparatus of any of the first aspect, and comprising an outer housing configured to receive the apparatus in an inner cavity defined by an inner surface of the outer housing.

The outer housing may be configured to cover at least one port provided in the apparatus.

The inner surface of the outer housing may be at least partially coated with an intumescent material.

The outer housing may comprise a bracket configured to attach to a support structure.

The assembly may comprise at least one split grommet configured to be located in the outer housing for receiving a direct current cable connected to at least one of the mating direct current connectors.

The outer housing may be configured to hold the at least two parts of the housing together.

The outer housing may have at least one outer surface configured to direct water to an edge of the outer housing.

The assembly may comprise mating direct current connectors having a rating defined by a manufacturer of the direct current connectors, and wherein the size of the air gap is selected to enable the direct current connectors to operate at or below said rating.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### FIGURES

Examples will now be described in further detail, by way of example only, with reference to the following examples and accompanying drawings, in which:

FIGS. 1A to 1C show different views of a first example configuration; and

FIGS. 2A to 2C show different views of a second example configuration.

### DETAILED DESCRIPTION

The following aims to address at least one of the above-identified problems. In particular, the following relates to providing an enclosure for containing fire resulting from arcing at DC connectors and preventing the consequent spread of the fire to surrounding materials. This has particular application to enclosures for containing arcing in photovoltaic solar systems and preventing the spread of fire to, for example, roofing elements and adjacent photovoltaic solar systems. The presently disclosed system also aims to allow DC connectors to work under their normal operating conditions without increasing the risk of arcing.

These problems may be addressed by an apparatus as described further below that encloses mating DC connectors within a fireproof enclosure while maintaining a sufficient air gap around the mating DC connectors. The apparatus may also provide ventilation openings to encourage air-flow for keeping the connectors below the maximum operating temperature defined by the manufacturer. Such an enclosure may help prevent the spread of fire from the inside to the outside, inhibit water ingress into the enclosed space, and/or allow for the drainage of any water should moisture collect inside the enclosure.

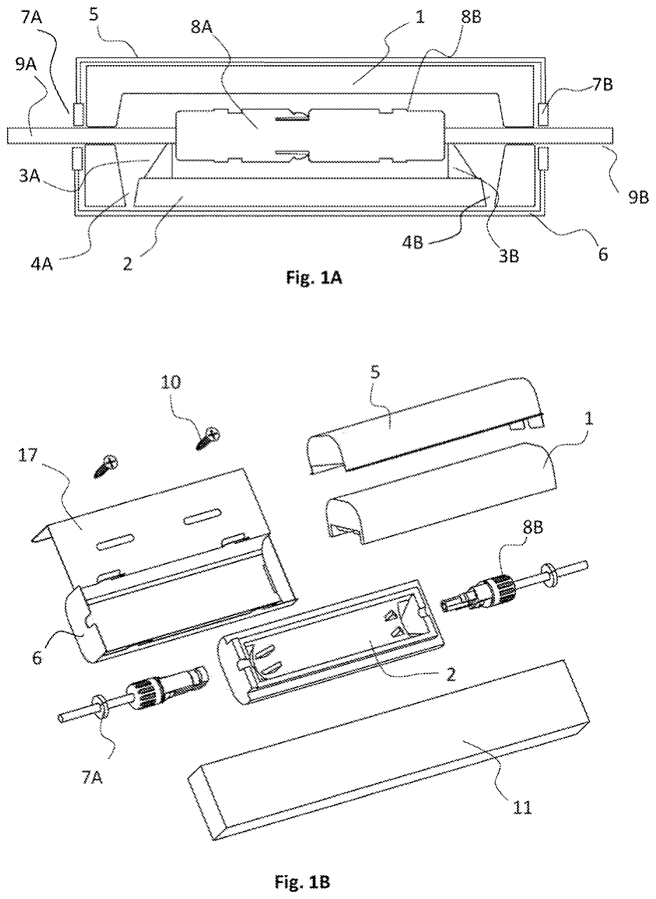

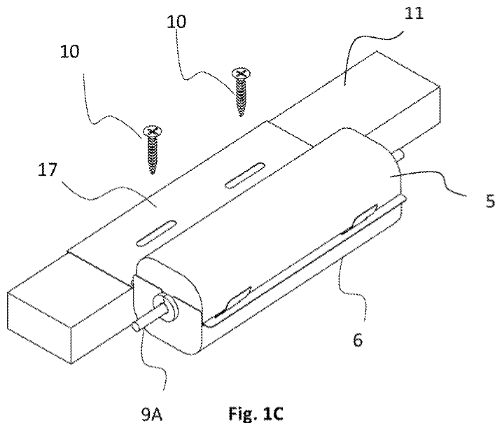

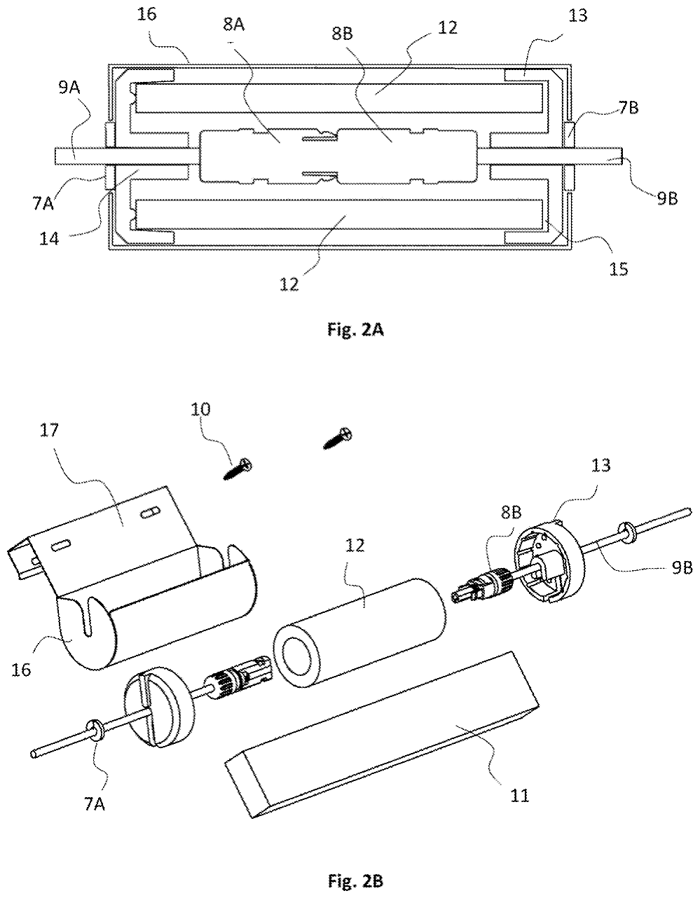

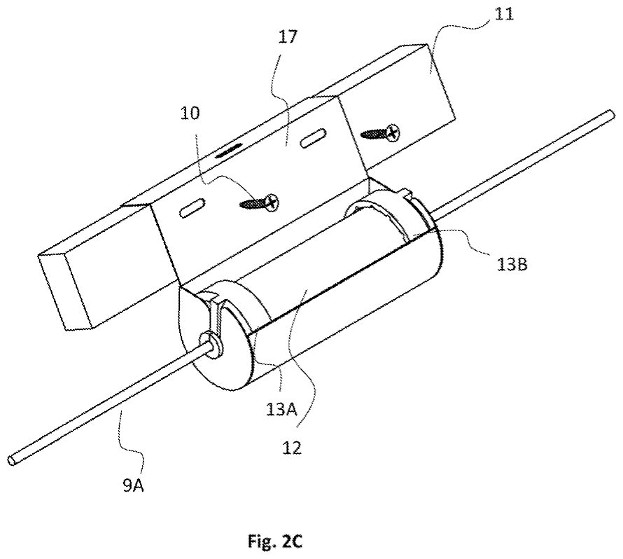

The provided enclosure is described in terms of an inner housing, as presented further below. In addition to this inner housing, the following discloses an outer housing that may provide further technical advantages when assembled with the inner housing. These are described in general below, before more specific examples are illustrated with respect to FIGS. 1A-2C.

In general, the following discloses an inner housing that defines a chamber of air/cavity of air within which mating DC connectors may be located. The defined chamber may enclose the mating DC connectors. In other words, the defined chamber may simultaneously surround the mating DC connectors on all sides of the mating DC connectors. This means that there are no open ends of the inner housing.

The air gap may be at least x mm around the mating DC connectors bar where at least one support member is provided proximal to the DC connectors (see below), where x may be dependent on an amount of heat expected to be output by the DC connectors during operation, and/or the number of air vents/ports provided in the inner housing. In other words, in some example configurations, there may be no part of the inner housing within x mm of the mating DC connectors. In other example configurations, the only part of the inner housing within x mm of the mating DC connectors may be at least one support member for positioning the mating DC connectors within a central region of chamber and/or inhibiting lateral movement of the DC connectors within the chamber. As a particular example, x may be 5 mm.

The inner housing may be provided with at least one support member that helps to position the mating DC connectors within a central region of chamber (particularly longitudinally within the chamber). The at least one support member may assist in positioning the mating DC connectors by contacting at least one of the cables associated with the mating DC connectors. The at least one support member may inhibit lateral movement of the DC connectors within the chamber. The at least one support member may be located at a distal end of the housing (i.e. away from the central region). The at least one support member may be located proximal to the central region. Where there are a plurality of support members, the support members may be located both proximal to and distal to the central region.

This inner housing is configured such that there exists at least one port for fluid flow. The ports may be formed proximal to where the parts of the inner housing mate as a result of the configuration of the edges of the mating parts. In addition or alternatively, the ports may be configured as holes or channels that extend through the inner housing.

Water may be drained out of the inner housing through these ports (in the event there is any water ingress), and/or ventilation may be provided to assist in heat dissipation via air flow through these ports. These ports may have an inner surface through which the fluid flows into and/or out of the inner housing, the inner surface being at least partially coated with an intumescent material. Under heating (e.g. when a fire is present in the enclosure), the intumescent material may swell up, blocking the ports. This may assist in quenching the fire as air flow is restricted. To a similar effect, an area of the inner housing proximal to the ports may be at least partially coated in an intumescent material.

The ports may be defined by the mating geometry of the parts (e.g. so that a port is formed where separate parts of the inner housing meet) and/or by holes located in the parts themselves. The ports may be located in the inner housing at at least one distal end of the housing. In other words, when mating DC connectors are located in a central region of the chamber, the ports may be located relatively far away from this central region.

The inner housing may be formed of at least one material for inhibiting the spread of fire. For example, the inner housing may be made of at least one material that can withstand high temperature resulting from a fire within the enclosure and the corresponding thermal shock. In other words, the material of the inner housing may be selected to ensure that the inner housing is unlikely to suffer from cracks after the thermal shock resulting from a fire within the enclosure. This property of not burning when exposed to such fires may be referred to herein as being fire proof, fire resistant, incombustible, etc. This is described further below in relation to ceramic materials.

The inner housing may be provided in a dielectric material. Providing the inner housing in a dielectric material may minimise the likelihood of arcing continuing via the housing if a connector body has burnt away.

The following also describes an outer housing that covers at least part of the inner housing. In other words, the outer housing may comprise at least one inner surface that receives an outer surface of the inner housing. The outer housing may hold together at least two parts of the inner housing, obviating the need for a further connection mechanism between the parts of the inner housing (although it is understood that an additional connection mechanism may be provided in examples).

The outer housing may be configured to cover at least the ports of the inner housing in order to inhibit water ingress and flame egress.

The outer housing may comprise its own ports for a similar purpose as the ports of the inner housing. The ports of the outer housing may not align with the ports of the inner housing. By comprising non-aligning ports, a labyrinthine path for fluid ingress and/or egress may be created, which helps to inhibit water ingress and flame egress. The inner and outer housing ports may be configured to maintain the temperature surrounding the mating DC connectors to be within the manufacturers rating for those mating DC connectors.

At least part of the inner surfaces of at least one of the inner housing and the outer housing may be coated in an intumescent material. The intumescent material may be selected such that, at a likely fire temperature resulting from the arcing, the material swells. This may assist in quenching the fire or to close off ports and limit the risk of flame egress in the event of an arc.

The outer housing may further comprise a sealing device, such as a gasket or grommet, that assists in inhibiting water ingress into the outer housing where a DC cable of the DC mating connectors enters the outer housing, and/or to prevent flame egress.

Specific examples of how the presently described techniques may be implemented are illustrated with respect to FIGS. 1A to 2C.

FIGS. 1A to 1C show differing views of a same example apparatus and assembly. FIG. 1B shows an exploded view of the assembly, while FIG. 1C shows an isometric view of the assembly.

FIGS. 1A to 1C shows a first cable 9A that connects with a second cable 9B via respective connectors 8A and 88. The connectors are surrounded by an air gap (not labelled). This air gap may be at least 5 mm. The cables 9A, 9B are supported at respective ends by inner housing 1, 2, which surrounds the DC connectors 9A, 9B. In this example, the inner housing 1, 2 comprises two separate parts for easier assembly (discussed below). The cables 9A, 9B are also supported at respective ends by additional supports 3A, 3B, which are connected to inner housing 2.

The cables 9A, 9B are further supported in a central position by respective retention devices 7A, 7B (e.g. grommets or gaskets) in an outer housing 5, 6 that encloses the inner housing 1, 2. The retention devices 7A, 7B may also provide a sealing function by inhibiting water ingress and flame egress where the cables 9A, 9B enter the outer housing. The inner housing also comprises holes 4A, 4B to allow water egress and air ingress, although it is understood that not all of these may be shown. Further, the holes 4A, 4B may be configured to extend to the external surface of the outer housing 5, 6 in a labyrinthine manner in order to inhibit water ingress and flame egress. The outer housing 5, 6 may be attached to a bracket 17 for fastening to a roof structure 11 (or any structure 11 for a PV system) via fasteners 10. Structure 11, which may be, for example, roof batten of timber and/or support rails that may be made of metals such as steel or aluminium.

During assembly, the DC connectors 8A, 8B are joined together before being placed on one of the inner housing parts 1, 2. A cavity comprising the DC connectors 8A, 8B is then formed by connecting the remaining one of the inner housing parts 1, 2. The outer housing 5, 6 parts are connected together over the inner housing 1, 2 to fully enclose the inner housing 1, 2. The outer housing 5, 6 may comprise at least one slot in its end plates to allow the cables 9A, 9B to slide into position when the outer housing parts are being joined. The outer housing is then attached to structure 11 via bracket 17 and fasteners 10. The bracket 17 may be integral with at least part of the outer housing, or may be independent of the outer housing.

FIGS. 2A to 2C illustrate another example apparatus and assembly in accordance with the presently described techniques. FIG. 2B shows an exploded view of the assembly, while FIG. 2C shows an isometric view of the assembly.

In contrast to the example of FIGS. 1A to 1C, which shows inner housing 1, 2, made up of two parts, an upper section 1 and lower section, FIG. 2 shows an example having an inner housing comprising a tube section 12 and two end caps 13, 14 that act to prevent the escape of flame from the ends of the tube by covering the ends of the tubes.

FIGS. 2A to 2C show a first cable 9A that connects with a second cable 9B via respective connectors 8A and 8B. The connectors are surrounded by an air gap (not labelled). This air gap may be at least 5 mm. The cables 9A, 9B are supported at respective ends by end caps 13A, 13B, which contact part of the cables 9A, 9B at supports 14A, 14B, but which do not surround the DC connectors 8A, 8B. Tube section 12 (which may be made out of a fireproofing/fire resistant material) contacts both end caps 13A, 13B at respective ends of its tube shape. Tube section 12 radially surrounds the DC connectors-8A, 8B when in use.

The cables 9A, 98 are further supported in a central position by respective retention devices 7A, 7B (e.g. grommets or gaskets) in an outer housing 16 that encloses the tube section 12 and end caps 13A, 13B. The retention devices may also act as a sealing device that helps to inhibit water ingress into the outer housing 16. The tube section 12 and/or end caps 13A, 13B also comprises holes 15 (or are otherwise configured to provide at least one egress port) to allow water egress and air ingress, although it is understood that not all of these may be shown. Further, the holes/port 15 may be configured to extend to the external surface of the outer housing 16 in a labyrinthine manner in order to inhibit water ingress and flame egress. The outer housing 16 may be attached to a bracket 17 for fastening to a roof structure 11 (or any structure 11 for a PV system) via fasteners 10. Structure 11, which may be, for example, roof batten and/or support rails may be made of metals such as steel or aluminium.

During assembly, at least one of the cables 9A, 9B may be slid into their respective end cap 13A, 13B and passed through the tube section 12 such that their DC connector 8A, 8B emerges from the other end of the tube section 12. The DC connectors may then be mated together before being relocated to a central inner region of the tube section 12. The remaining end cap 13A, 13B may then be slid onto the remaining cable 9A, 9B and affixed to the other end of the tube section 12.

The inner housing is then placed in outer housing 16 such that the outer housing partially surrounds the inner housing. The outer housing 16 may comprise at least one slot in its end plates to allow the cables 9A, 9B to slide into position when inserted into the outer housing 16. The outer housing 16 is then attached to structure 11 via bracket 17 and fasteners 10. The bracket 17 may be integral with at least part of the outer housing 16, or may be independent of the outer housing.

The following describes features that may apply to both of the above-described specific examples. It is understood that the following described features may also be applied to other example configurations of inner and outer housings (not described), such as, for example cuboid configurations. In other words, the following disclosure is not limited to these specific examples, but are merely illustrated using the specific examples.

In both of these examples, by supporting the cables at each end of the DC connectors, contact between the connectors themselves and the material in the enclosure is avoided. The support also acts as a cable restraint to make sure that the connectors are in the central position for maximum fire protection and ventilation. Moreover, this arrangement reduces the risk of contact with incompatible materials which may compromise the longevity of the connectors. The DC connectors may be multi-contactMC4 (or similar) connectors.

Both of the examples of FIGS. 1 and 2 provide support features 3, 14 that can be an integral part of the inner housing. These are separate from support that may be provided by the outer housing via gaps for the cables 9A, 9B (including any grommets). The support feature may be positioned at a location to ensure an air gap of at least 5 mm around the DC connectors. The support feature may also be configured to prevent lateral movement of the connectors inside the inner housing. For example, the support features 3 may be manufactured such that they almost abut an edge of the DC connectors 8A, 8B.

The inner housing (1, 2, 12, 13) may be made of ceramic materials that can withstand high temperature and the corresponding thermal shock. A wall thickness of 10 mm may achieve the above objectives. The ceramic material may be selected to make sure that the device does not suffer from cracks after the thermal shock. The selected ceramic material has dielectric properties to prevent the circuit continuity should the connectors fall apart due to arc damage and come in to contact with the device.

The above-mentioned inner housing of FIGS. 1 and 2 may be manufactured from materials such as alumina cement or calcium aluminate. In more detail, the inner housing of FIG. 1 may be made by casting from fireproofing material. Further, the tube section 12 of FIGS. 2A to C may be manufactured from fireproofing materials by extrusion, while the two end caps may be manufactured by casting or machining from dense machinable ceramics. It is understood that this method of manufacturing the components is not limiting.

The inner housing may be configured to maintain temperature below 105° C. at 39 Amps current flow through the connector and at 85° C. in ambient conditions. This may be achieved by a trade-off between the air gap surrounding the DC connectors and the number and size of ventilation and/or drainage ports in the inner housing. In other words, the configuration of the inner housing may be so as to maintain the temperature inside the cavity below the maximum operating temperature rated for the DC connector at its rated current and ambient temperature.

At least one outer surface of the inner and/or outer housing may be shaped to shed water and discourage water ingress into the chambers/cavities they define. This may be performed as a result of, for example, contouring the at least one outer surface to direct water incident on the at least one outer surface to an edge of the at least one outer surface. The edge, in the present context, is a location from which the water may separate from the outer housing and/or inner housing under the influence of gravity.

Overall, the enclosure is provided with sufficient drainage holes or ports 4, 15 to allow gravity drainage of any moisture that might accumulate in the enclosure, whatever the installed orientation of the enclosure. Drainage holes may be positioned radially at the ends of the enclosure to be furthest from the most likely point of arcing in the centre of the cavity created by the inner housing.

The outer housing 5, 6, 16 may hold together all the components of the inner housing by creating an inner cavity within which the DC connectors 8A, 8B may be contained. The outer housing may overlap at least some of the drainage and ventilation holes of the inner housing to create a labyrinthine path and prevent the escape of flame while allowing the movement of water and air from within the enclosure to aid ventilation and to ensure the connector is kept dry.

It is understood that the outer housing described in respect of FIGS. 1A to 1C may be used as outer housing in the system of FIGS. 2A to 2C, and vice versa.

A coating of intumescent material (i.e. a material that expands to an increased volume at elevated temperatures) may be applied to the inside faces of the outer housing to close ventilation and drainage holes in the event of an arc.

The outer housing in both of the described examples are provided with retention devices 7. These retention devices may prevent cable chafing and provide a better seal around the cable inlet than is provided in their absence. These retention devices may be made from an ethylene propylene diene monomer (EPDM) rubber. These sealing gaskets may be split gaskets that allow cable insertion even when the cable already has the connector on the end.

The DC connectors 8A, 8B and cables 9A, 9B may be commonly used standard components in the PV industry. For example, given current specifications, they may have a maximum operating temperature in accordance with the required electrical standards, i.e., IEC 60512 May 1 and IEC 62852, carrying 105° C. at a current carrying load of 39 Amps and an ambient temperature of 85° C. for 4 mm² DC cable. It is understood that the actual connectors, cables and configuration may be selected to comply to a specific electrical standard being applied to the system being installed.

The above provides some specific examples of how the present disclosure may be implemented, along with more general principles that are illustrated with respect to the specific examples of FIGS. 1A-2C. It is understood that this is not limiting. A general disclosure of the inner housing, outer housing and an assembly comprising the two housing apparatuses is provided below, where the inner housing is simply referred to as “housing”. It is understood that features described above in relation to the specific examples may also form part of this more general disclosure.

As a first aspect, there is provided an apparatus for an enclosure of a direct current connection of a photovoltaic solar panel, the apparatus comprising an inner housing. The inner housing comprises at least two parts that, when joined together, form a chamber for surrounding mating direct current connectors with an air gap.

The housing comprising at least one support structure for positioning the direct current connectors in a central part of the chamber.

The at least one support structure is configured to contact at least one cable connected to one of the mating direct current connectors for causing the direct current connectors to be suspended in air in a central region of the chamber. The at least one support structure is configured to inhibit lateral movement of the mating direct current connectors in at least one direction. The at least one support structure may inhibit lateral movement of the mating direct current connectors by contacting the at least one cable. Inhibiting movement of the direct current connectors helps to retain the direct current connectors in enough of an air gap for the direct current connectors to operate at or under the manufacturer's rating for the direct current connectors. Where the direct current connectors have different manufacturer ratings, the most restrictive rating is applied.

The housing comprises an inner surface facing the chamber that may be at least partially coated in an intumescent material. This coating may be located near/proximal to at least one port (discussed further below).

The apparatus may comprise at least one first port for providing water egress from the fire-resistant housing. The apparatus may comprise at least one second port for air flow into and/or out of the chamber. The at least one first port and/or the at least one second port may be provided by a configuration of the mating of the parts of the housing. The at least one port and/or at least one second port may be formed by a channel extending through the housing.

The at least one first and/or second port may provide an entrance or exit point to a labyrinthine path for exit of water and/or entry of air and/or exit of air. The at least one first and/or second port may be located at a distal end of at least one part of the housing. The at least one first port and/or second port may comprise respective inner surfaces, of which at least one may be partially coated in an intumescent material.

The housing may comprise an upper part and a lower part that mate together to surround the mating direct current connectors. This may be as described, for example, with reference to FIGS. 1A to 1C.

The housing may comprise a tubular section having two open ends, and two end caps configured to cover the open ends of the tubular section. This may be as described, for example, with reference to FIGS. 2A to 2C.

The housing may comprise a dielectric material. The dielectric material may be a ceramic material. The dielectric material may be selected to be unlikely to develop cracks from thermal shocks from fires originating within the enclosure. The use of a dielectric material prevents electrical continuity via the housing if a DC connector body burnt away.

The housing may have at least one outer surface configured to direct water to an edge of the housing. In other words, the housing may be configured to shed water that lands on it. This may be achieved through contouring the outer surface(s) of the housing in any of a plurality of ways.

The housing described above may be comprised within an assembly that also comprises an outer housing configured to receive the apparatus in an inner cavity defined by an inner surface of the outer housing. The outer housing may be configured to hold the at least two parts of the housing together. In other words, the outer housing may be configured to act as a retention mechanism for holding together parts of the housing.

The outer housing may be configured to cover at least one port provided in the apparatus. The outer housing may be provided with at least one channel extending therethrough to provide at least one third port. The location of the third port may be selected so that when the outer housing is assembled with the housing, as described above, the first, second, and third ports either do not align or only partially align (i.e. there is no full alignment of ports). This helps to inhibit water ingress and flame egress.

At least part of the inner surface of the outer housing may be at least partially coated with an intumescent material. The intumescent material may be proximal to at least one port provided by the apparatus (e.g. the first and/or second port), and/or may be proximal to the third port(s).

The outer housing may comprise a bracket configured to attach to a support structure.

The assembly may comprise at least one split grommet configured to be located in the outer housing for receiving a direct current cable connected to at least one of the mating direct current connectors.

The outer housing has at least one outer surface configured to direct water to an edge of the outer housing. In other words, the outer housing may be configured to shed water that lands on it. This may be achieved through contouring the outer surface(s) of the housing in any of a plurality of ways.

The assembly may further comprise mating direct current connectors. The mating direct current connectors may each be associated with a respective manufacturers rating. The size of the air gap may be configured to enable the direct current connectors to operate at or below the most restrictive of said ratings. The air gap may be at least 5 mm.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus for an enclosure of a direct current connection of a photovoltaic solar panel, the apparatus comprising:
a housing comprising at least two parts that, when joined together, form a chamber for surrounding mating direct current connectors with an air gap, the housing comprising at least one support structure for positioning the direct current connectors in a central part of the chamber.

2. The apparatus as claimed in claim 1, wherein the at least one support structure is configured to contact at least one cable connected to one of the mating direct current connectors for causing the direct current connectors to be suspended in air in a central region of the chamber.

3. The apparatus as claimed in claim 2, wherein the at least one support structure is configured to inhibit lateral movement of the mating direct current connectors in at least one direction.

4. The apparatus as claimed in claim 1, wherein the housing comprises an inner surface facing the chamber that is at least partially coated in an intumescent material.

5. The apparatus as claimed in claim 1, comprising at least one first port for providing water egress from the housing.

6. The apparatus as claimed in claim 1, comprising at least one second port for air flow into and/or out of the chamber.

7. The apparatus as claimed in claim 5, wherein the at least one first port and/or at least one second port provides an entrance or exit point to a labyrinthine path for exit of water and/or entry of air and/or exit of air.

8. The apparatus as claimed in claim 5, wherein the at least one first and/or at least one second port is located at a distal end of at least one part of the housing.

9. The apparatus as claimed in claim 5, wherein the at least one first port and/or at least one second port comprises a respective inner surface that is at least partially coated in an intumescent material.

10. The apparatus as claimed in claim 1, wherein the housing comprises an upper part and a lower part that mate together to surround the mating direct current connectors.

11. The apparatus as claimed in claim 1, wherein the housing comprises a tubular section having two open ends, and two end caps configured to cover the two open ends of the tubular section.

12. The apparatus as claimed in claim 1, wherein the housing comprises a dielectric material.

13. The apparatus as claimed in claim 1, wherein the housing has at least one outer surface configured to direct water towards an edge of the housing.

14. An assembly comprising:
the apparatus of claim 1, and
an outer housing configured to receive the apparatus in an inner cavity defined by an inner surface of the outer housing.

15. The assembly as claimed in claim 14, wherein the outer housing is configured to cover at least one port provided in the apparatus.

16. The assembly as claimed in claim 14, wherein the inner surface of the outer housing is at least partially coated with an intumescent material.

17. The assembly as claimed in claim 14, wherein the outer housing comprises a bracket configured to attach to a support structure.

18. The assembly as claimed in claim 14, further comprising at least one split grommet configured to be located in the outer housing for receiving a direct current cable connected to at least one of the mating direct current connectors.

19. The assembly as claimed in claim 14, wherein the outer housing is configured to hold the at least two parts of the housing together.

20. The assembly as claimed in claim 14, wherein the outer housing has at least one outer surface configured to direct water to an edge of the outer housing.

21. The assembly as claimed in claim 14, wherein the mating direct current connectors have a rating defined by a manufacturer of the direct current connectors, and wherein a size of the air gap is selected to enable the direct current connectors to operate at or below said rating.
